(19) United States
(12) Patent Application Publication
(10) Pub. No.: US 2009/0307676 A1
(43) Pub. Date: Dec. 10, 2009

(54) Dead Functions Elimination in Dynamic Linked Libraries for Code Size Reduction of Operating Systems in Embedded Systems

(75) Inventors: Howard Price, Buckinghamshire (GB); Aleksandar Antonic, Essex (GB)

Correspondence Address: Saul Ewing LLP (Philadelphia), Attn: Patent Docket Clerk, 2 North Second St., Harrisburg, PA, 17101, US

(73) Assignee: Nokia Corporation

(21) Appl. No.: 12/295,883

(22) PCT Filed: Apr. 5, 2007
(86) PCT No.: PCT/GB07/01273

§ 371 Date: Jan. 29, 2009

(30) Foreign Application Priority Data
Apr. 7, 2006 (GB) 0607068.4
Dec. 20, 2006 (GB) 0625409.8

(51) Int. Cl. G06F 9/45

(52) U.S. Cl. 717/162

(57) ABSTRACT

This invention relates to a method for reducing the size of a set of computer code by replacing unused functions in the set of code with void functions having no operative content. The invention may be applied to a core operating system in order to reduce the amount of code that is permanently loaded on a computing device while the device is operating, thereby potentially reducing the requirements for both read-only non-execute-in-place memory and randomly addressable memory. The removed functionality may be provided separately in read-only memory if desired, so that it can be loaded when needed.

This invention relates to reducing the size of computer code, and in particular but not exclusively to reducing the size of software to be embedded in a computing device.

The term computing device as used herein is to be expansively construed to cover any form of electrical computing device and includes, data recording devices, computers of any type or form, including hand held and personal computers such as Personal Digital Assistants (PDAs), and communication devices of any form factor, including mobile phones, smart phones, communicators which combine communications, image recording and/or playback, and computing functionality within a single device, and other forms of wireless and wired information devices, including digital cameras, MP3 and other music players, and digital radios.

Modern computing devices generally contain multiple types of memory. Memory can be broadly categorised into two types:
Memory that can be used for programs that eXecute In Place (XIP), that is where the programs do not need to be loaded into a different form of memory in order to execute. The various types of RAM (Random Access Memory) are the most prominent examples of this type. However, because RAM is volatile and loses its contents when powered down, many devices include smaller amounts of the more expensive but slower varieties of non-volatile XIP memory such as NOR Flash.
Memory that can be used for storage, but not for XIP; generally this is because it can only be accessed sequentially or in blocks, rather than being randomly addressable. Disk drives and NAND Flash are prominent examples of this type. Programs kept in storage memory have to be copied to XIP memory in order to be able to run.

There is additionally one significant difference between these two types of memory; XIP memory is much more expensive than memory which can only be used for storage. Because there are considerable cost pressures on the manufacture of modern computing devices, including portable devices such as mobile telephones which are aimed at the price sensitive mass market, it is desirable that such devices should wherever possible minimise their requirements for XIP memory.

It is known that there is a requirement for computing devices to be provided with software that is essential to the proper functioning of the device in some type of permanent non-volatile storage as part of the manufacturing process. Such software commonly includes data and programs that are necessary to the boot-up procedures that run when the device is powered up, or that provide Operating System (OS) services that are required frequently, or that provide critical applications.

Devices that keep as much as possible of this type of software in storage memory, copying it to XIP memory (loading it) when needed and releasing the XIP memory when no longer needed (unloading it), are able to minimise their manufacturing costs compared to devices that keep more of this software in XIP memory.

More specifically, where the core operating system (OS) of a device has been provided in storage memory at manufacture time, it generally needs to be copied as an entire OS image from storage to XIP memory as part of the startup (boot) process. The term “core OS” is used here in a general sense to refer to the parts of an OS that are essential to the basic operation of a computing device. An “OS image” is a file representing the entirety of the OS software. The size of an OS image is thus the footprint of the OS when stored in memory.

In general, once loaded into XIP memory an OS image cannot be practically unloaded, even in part; it is known to those skilled in the art that because such OS images are typically built using a technique known as static linkage, the memory locations they occupy must be regarded as reserved and are not available for reuse by other software.

A device that minimises the size of the core operating system will be able to minimise the fixed cost of providing XIP memory dedicated for its use, thus minimising the requirements of the device for XIP memory and making it less expensive to buy and more accessible to the general public. It also provides the benefit that less storage memory is required to store the core OS.

Where manufacturers of computing devices provide such devices as families of products, with each member of a family exhibiting different functionality but being developed from the same or similar software, it is desirable from a device manufacturer's perspective for all the members of a family of products to include compatible core operating systems. It is known that this both decreases development costs and increases reliability. Furthermore, where such devices are open and permit the post-manufacture installation of software modules providing additional functionality, compatible core operating systems may enable the utilisation of the same such software modules across an entire family of products.

In the market for computing devices, and especially portable devices such as mobile telephones, related members of product families are typically differentiated by price points and by feature sets. In general, lower priced members of the product family are provided with a lesser feature set (either hardware or software related). This is a well-known phenomenon; see, for example, the account at http://news.bbc.co.uk/2/hi/business/5274352.stm which explains that:

“In the hi-tech world it is common to produce a high-specification product, sold at a premium price, and then sell the same product more cheaply with some of the functions disabled.”

If, for reasons of maintaining OS compatibility within a product family, a core operating system that offers support for a full range of features has to be installed on a member of the product family that was designed to offer a lesser range of features, it is clear that those portions of the OS that offer support for features that are not present constitute wasted memory. If the core OS image is built using static linkage, it will generally not be feasible to reuse the wasted memory addresses occupied by the code implementing these unused features. This is because the core OS image constitutes a monolithic block of code in which memory addresses are written into the programs and it would not be practical to interleave additional code into the wasted addresses associated with OS code that is not used.

On computing devices which copy the core OS from storage to XIP memory, including support for unavailable features bloats the operating system and adds to manufacturing costs without contributing any value. It also increases start-up time, as the support code needs to be copied from storage to XIP memory even though it will not be used.

It is of course possible to manufacture an alternative version of the core operating system without these unused portions. However, such a version would necessarily abandon a number of the considerable economic benefits to both the manufacturer and its customers of maintaining a coherent product family in two significant respects.
1. Such a version of the core OS may not benefit from compatibility with the original, full, version. In particular, any software installed post-manufacture that relied on code that was supposed to reside in the fully featured version of the core OS would fail to work.
2. Because an alternative version of the OS would fragment the product family it would require separate development and testing, thereby increasing development costs and time to market.

It is thus desirable to provide a way of removing unused functions, and thereby reducing the size of a set of code, while mitigating the problems set out above.

According to a first aspect of the present invention there is provided a method of reducing the size of a set of computer code intended for use in a computing device, the code comprising a plurality of files, each specifying one or more functions for performing computing tasks, the method comprising: identifying functions within the set of code that: i) are available to be called by others of the functions; and ii) will not be called by others of the functions when the files are executed on the computing device; and removing from the set of code at least part of the content defining the identified functions while retaining, in place of each identified function, a void function of reduced size.

The void function preferably contains no operative code.

Each of the identified functions in the set of code is preferably associated with an ordinal number specifying the position of the function within a defined order, and, for each identified function, the step of removing content preferably results in the creation of a void function having the same ordinal number as the identified function.

The set of code may be an operating system or a part of an operating system.

The said identified functions are preferably exported functions.

The method may further comprise, for at least one of the files containing one or more void functions, creating complementary code for the respective file, the complementary code containing functionality that was removed in the said step of removing at least part of the content, such that a combination of: i) the reduced file containing one or more void functions, and ii) the complementary code, provides functionality equivalent to that of the original file.

The method may further comprise the step of storing: i) the set of code, including the reduced file, and ii) the complementary code as separately loadable files in storage memory of the computing device in which code cannot execute in place.

The method may further comprise providing a linking arrangement configured to link between functions in the reduced set of code and functions in the complementary code, such that all functionality provided by the original set of code can be provided by the combination of the reduced set of code and the complementary code.

The method may further comprise the step of storing: i) the reduced set of code, including any void functions, and ii) each file that contains identified functions, in its original form, as separately loadable files in storage memory of the computing device in which code cannot execute in place.

The method may further comprise providing a linking arrangement configured to link between functions in the reduced set of code and functions in the said separately loadable files, such that all functionality provided by the original set of code can be provided by the combination of the reduced set of code and the separately loadable files.

The method may further comprise removing from the set of code any files containing only void functions.

The method may further comprise storing, in storage memory of the computing device in which code cannot execute in place, and as separately loadable files, the said removed files in the form in which they existed prior to the step of removing content defining the said identified functions.

The method may further comprise the steps of: identifying further functions within the set of code that: i) are available to be called by other functions within the same files as the said further functions; and ii) will not be called by other functions when the files are executed on the computing device; and removing from the set of code the identified further functions.

According to a second aspect of the present invention there is provided a set of code intended for use on a computing device, the set of code comprising a plurality of files, each specifying one or more functions for performing computing tasks, wherein those of the functions that: i) are available to be called by others of the functions; and ii) will not be called by others of the functions when the files are executed on the computing device; are present in the set of code only as void functions having no operative code.

According to a third aspect of the present invention there is provided an operating system comprising the set of code as defined above.

According to a fourth aspect of the present invention there is provided a computing device having non-volatile memory, the memory containing the set of code defined above. The memory may be storage memory in which code cannot execute in place.

The memory may additionally contain, as one or more separately loadable files, complementary code including operative functions, the complementary code being arranged for execution with one or more of the void functions to perform computing tasks.

Each void function may be associated with an ordinal number specifying the position of the function within a defined order, and the complementary code may be arranged to be invoked by linking via an ordinal number associated with a void function in the set of code.

Alternatively or in addition, the memory may contain, as one or more separately loadable files, operative functions each associated with one of the void functions.

As will be seen from the following discussion, embodiments of the invention enable the RAM requirements of differently featured models of computing devices belonging to the same family to be matched to the feature level of particular models while retaining compatibility with other models in the same family. Embodiments of the invention may be particularly suitable for those devices where a core operating system image is provided in NAND Flash or other types of non-executable non-volatile storage memory, and where that image is copied into RAM at boot. The preferred embodiment of the invention involves identifying those functions that are unused within the core OS image, removing them from the executables they are found in, replacing them with stubs to ensure binary compatibility for those functions that remain, and building a revised core OS image using these “tiny variants” of the affected executables. A version of the executable containing the full version of the removed functions is then placed as a separately loadable module in storage memory for any after-market applications that may require them.

Embodiments of the invention can enable the XIP or RAM memory overhead of a computing device to be reduced in direct proportion to reduction in feature sets, while at the same time permitting compatibility between all members of a product family irrespective of the features they offer.

An exemplary implementation of the invention will now be described in detail with reference to the accompanying drawings, in which:

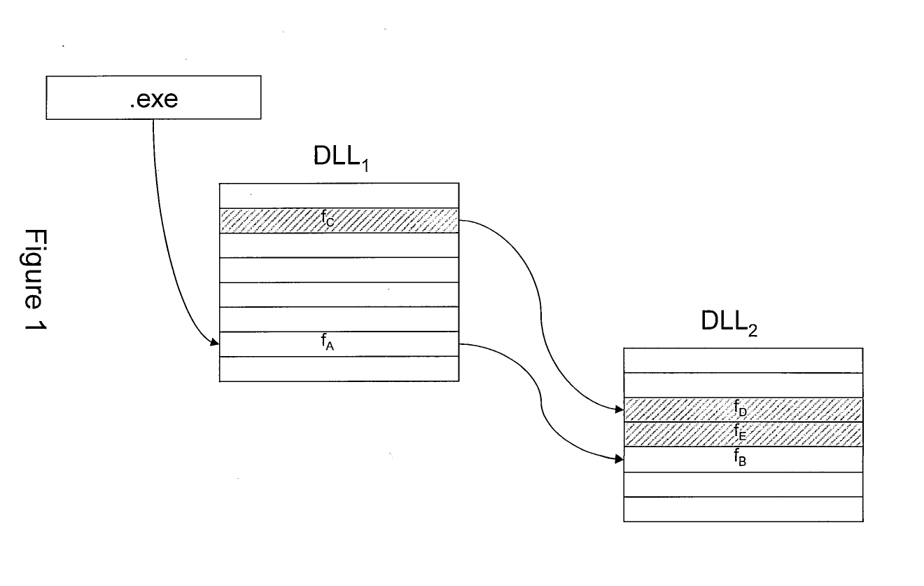

FIG. 1 illustrates the occurrence of unused functions;

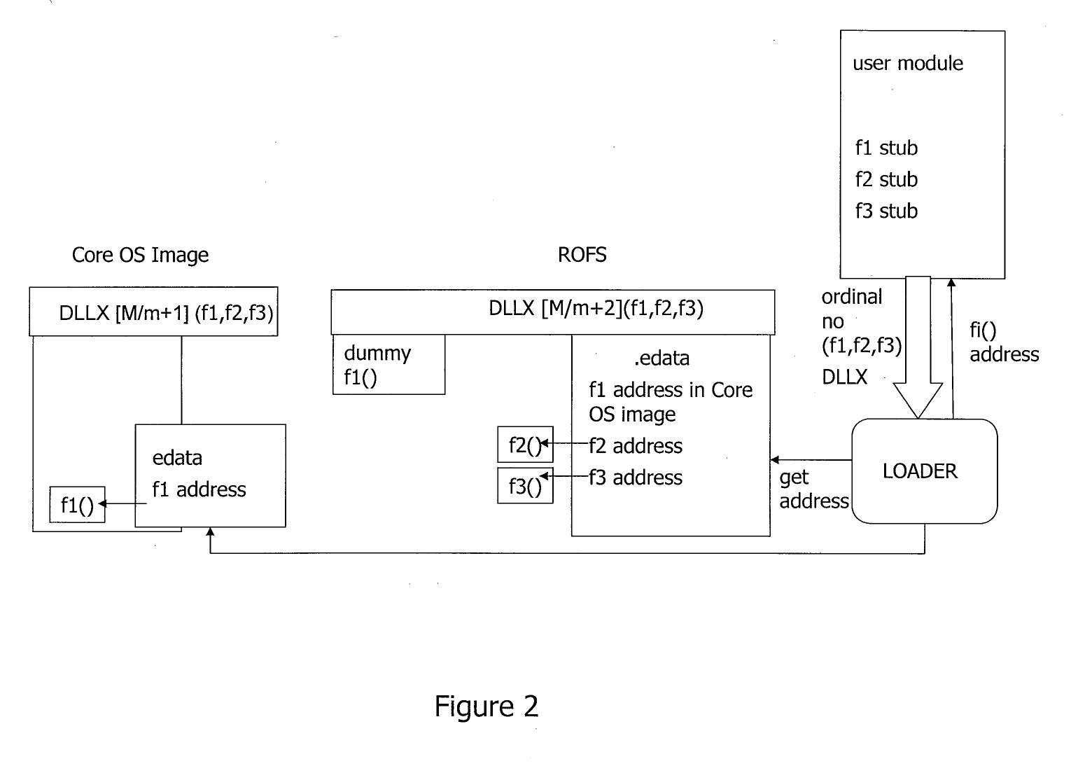

FIG. 2 represents an exemplary implementation of the invention; and

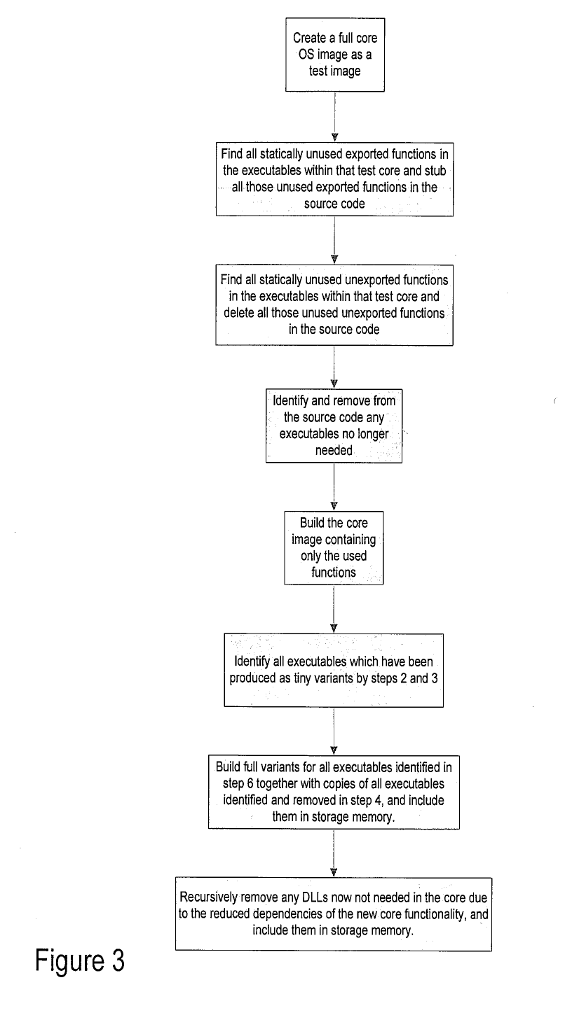

FIG. 3 is a flow chart illustrating a process for modifying software.

The preferred embodiment of the invention may advantageously be applied to reduce XIP or RAM memory on devices which provide their core operating system together with other (non-core) executables in NAND Flash storage memory. In such an arrangement, the core image contains executable files together with all their dependencies and is recursively copied from NAND Flash to RAM at boot. This core image is supplied as a single file on NAND Flash; when the image is copied into RAM, it then appears as multiple files in a conventional XIP read-only file system (ROFS). The remainder of the non-core executables remain in the non-XIP ROFS on NAND Flash and are loaded and unloaded on demand; unlike the contents of the core image, they do not have to occupy reserved sections of memory, and any resources they consume can be freed when they are no longer required.

As described above, provision of a fully-featured version of the core OS on a device with only a reduced feature set would inevitably allocate valuable and scarce XIP memory at boot time for a significant number of functions that are not needed by the rest of the core OS. Furthermore, because the entire core is statically linked, it is impractical for the RAM so allocated to be freed up for other purposes.

In accordance with the preferred embodiment of the invention, when a function in an executable file is identified as not being used in the particular version of the OS, it is stubbed for that version: any subroutines which depend on the unused function and are also unused are removed from the OS code, so that what remains is an executable file of reduced size that includes only a void function. A void function is one that does not run, and therefore does not perform any tasks.

For example, if a function previously appeared in the executable file as:

| | |
|---|---|
| void | func1( ) |
| | { |
| | func2( ) |
| | func3( ) |
| | func4( ) |
| | } |

then after stubbing it would appear as:

| | |
|---|---|
| void | func1( ) |
| | { |
| | } |

The stubbed function is empty: it contains no working code, and it now requires less memory space.

It should be noted that unused functionality may be identified and removed from code in accordance with the invention when the code is in human-readable or in computer-readable form. In most implementations it is likely to be preferable to identify and remove the functions from source code because in this form the code is more easily readable by an engineer for verification. However, tools could be developed for removing the functions once code has been compiled.

FIG. 1 illustrates the concept of unused functions by way of example. It shows a number of files within a core OS. An executable file “.exe” is shown to call a function f_{A} from a dynamic link library, DLL₁. A DLL is a type of executable file which typically contains a number of functions that can be used by functions in other executable files or other DLLs. f_{A} is known as an exported function, since it may be invoked by means of a call from a function in a different executable file or DLL. When f_{A} is called by the .exe file, DLL₁ is loaded into RAM and f_{A} executes, and it in turn calls a further function f_{B} that is held in DLL₂. DLL₂ is then loaded and f_{B} executed.

As can be seen from FIG. 1, DLL₁ and DLL₂ each contain a number of functions—example functions f_{C}, f_{D} and f_{E} are shown explicitly. FIG. 1 also shows schematically that f_{C}, when executed, will call f_{D} from DLL₂. However, suppose that no executable files in the version of the core OS of the present example ever invoke f_{C} f_{C} will therefore never run, and is an example of a function that represents wasted memory usage. The same is true in this example for f_{D}, which can only be called by f_{C}, and will therefore not be used in this core OS image version. A further function f_{E} in this example is held in DLL₂, and is not invoked by any executable functions in this version of the core OS image. f_{E} therefore also represents wasted memory usage.

The skilled person will be aware of various means by which unused function could be identified. Examples are linker feedback and caligraph analysis. However, linker feedback has been found by the present inventors to provide more reliable results, and is therefore the preferred technique. The armlink command, described in the RealView® Compilation Tools Linker and Utilities Guide Version 3.0 (http://www.arm.com/pdfs/DUI0206G_rvct_linker_and_utilities_quide.pdf, especially in sections 3.3.3 to 3.3.5, is an example of a tool that may be used to identify unused functions.

There are various reasons why functions in the original version of the core OS image are unused. These include:
1) They may support the use of hardware which is not present on all versions of the devices on which the OS is intended to be used. For example, the generic (original) OS may cater for the possible use of an SD card, whereas some devices on which the OS is implemented use no memory card, a Compact Flash card, or a USB-compatible memory stick. In such devices, the particular functionality provided for compatibility with an SD card is not required, and could therefore be removed.
2) They may relate to the use of an application that needs to be separately downloaded in order to operate on a device, but the application requires hardware that is not provided in certain devices. So, for example, an email messaging application that can be downloaded for use on certain devices may require the presence of a particular type of processor which may not be provided on all devices for which the generic OS is intended. Thus, the functions that would provide the email messaging capability will be unused on versions of the OS that are to be used on devices without the relevant processing capacity.

In addition, functions may be identified as “unused” when they are likely to be used only on an occasional basis, or used only by functions outside the core OS. This is an important aspect of the preferred embodiment of the invention, since in such cases it can be inefficient to have to load the functions as part of the core OS when they are not necessarily required for use.

It can be seen from FIG. 1, and from the corresponding part of the description above, that memory savings could be made if f_{C}, f_{D} and f_{E} could be removed from the OS image. While it would be possible to simply delete any reference to these functions from the OS, the preferred embodiment of the invention instead involves retaining a skeletal version, or stub, of the function. Where an unused function is identified, the executable retains a reference to the primary function (such as f_{C}). However the contents of that function, including the unused functions which would have been called by the primary function, are removed from the executable, thereby leaving the following form of function:

| | |
|---|---|
| void | func1( ) |
| | { |
| | } |

As an alternative to leaving a remnant of the original function, the function could be removed altogether and replaced with a marker indicating that the function is absent from the executable. Both of these alternatives are intended to be encompassed by the term “void functions” as used herein, which indicates the presence of an item of code having content which is inoperative or not fully operative, and which therefore is incapable of performing the computing tasks represented by the corresponding original function.

Ordinal number linking is utilised in the preferred embodiment: ordinal numbers, which are assigned to functions in an exported set (such as a DLL) indicate the position of one function relative to another function in a defined order. Ordinal numbers are the index by which functions are linked to in the preferred embodiment, so that a function calling another function will refer to the ordinal number of the other function (rather than, say, its name or its location in physical memory) in order to invoke it. In this embodiment, retaining a reference in a stub to a primary function has the advantage that binary compatibility with other members of a family may be retained, as discussed in detail below.

If a function having a particular ordinal number is unused and is thus a candidate for deletion, it is desirable to retain a stub of that function rather than deleting any reference to the function, so that the relative positions of all other functions in the same set do not shift within the predefined order. For example, simply deleting a function at ordinal number 9 may have the effect that functions at ordinal numbers 10 onwards assume new ordinal numbers 9 onwards, since the previous function 9 no longer exists in the order. This could be undesirable because the ordinal numbers of this version of code would no longer be compatible with other versions of the OS that retain the original ordinal numbering, and updates of the code may therefore need to be customised to the new numbering scheme. If many different forms of the OS were to exist for this reason, then there would be obvious impacts on the cost and viability of future improvements or additions to the OS.

Instead, it is preferred to retain a stub at the ordinal position of the unused function, in the manner illustrated above. In this way, the contents of the function are removed, but the function still exists in an empty form in the OS, thereby retaining its ordinal number so that binary compatibility with core OSs of other family members can be ensured, and extra functionality relying on the presence of the function previously at that ordinal number can be more easily added on.

In general, a given part of a set of code, that is intended for a specific end use but that will not necessarily be used in all implementations, is known as a variant. In the present description, the term variant is also used to refer to alternative versions of a particular piece of code, such as a DLL. In this description, executables that are provided only for certain end use cases but are unrequired in a particular implementation are referred to as tiny variants after they have been stubbed. The tiny variants have minimal function stubs, which replace the body of those functions that are not required for a reduced feature set. The tiny variants need not contain any operative code, that is they need not be capable of performing any computing tasks: they are simply used to replace the original full-featured components while maintaining the ordinal number of the original component.

Tiny variants may be created from any executable code components, including Dynamic Link Libraries (DLLs) and stand alone executables (EXEs). Because they are part of the core OS, these tiny variants are copied at boot time into XIP RAM instead of the fully featured variants. The originals (the full variants) of the DLLs and EXEs containing the selected components can then be provided as loadable executable program files in storage memory instead of as part of the core OS image; this is described in more detail below.

In the preferred embodiment binary compatibility between different core OS images is supported by means of rules governing the circumstances under which components loadable from storage memory can be used to replace components from a particular OS core image.

To illustrate these rules, suppose that executable FRED.EXE in the core OS image uses a DLL called JOE.DLL. The two will be statically linked when the core OS image is built. If you wish to modify JOE.DLL, then the modified version can be placed in memory storage; however, FRED.EXE still uses the original version from the core OS image, as they are statically linked. If, however, you add a new version of FRED.EXE in memory storage then it can now use the new version of JOE.DLL also in memory storage. Only those applications in the core OS image that were statically linked to it continue to use the version of JOE.DLL included in the image.

The application of these rules means that the provision of executables as separate files in storage memory which include the full versions of anything provided as a tiny variant in the core OS image allows any after-market executable loaded on to the device to function as intended; instead of linking to a DLL with tiny variants from the core OS image, such an executable would dynamically link and load the full version of the DLL provided in storage memory.

Taking advantage of these rules, the preferred embodiment of this invention further utilises the following mechanism for producing a core OS image that is compatible with other core OS images in the same family:
1. create a full core OS image as a test image
2. find all statically unused exported functions in the executables within that test core and stub all those unused exported functions in the source code
3. find all statically unused unexported functions in the executables within that test core and delete all those unused unexported functions in the source code
4. identify and remove from the source code any executables no longer needed
5. build the core image containing only the used functions
6. identify all executables which have been produced as tiny variants by steps 2 and 3
7. build full variants for all executables identified in step 6 together with copies of all executables identified and removed in step 4, and include them in storage memory.
8. recursively remove any DLLs now not needed in the core due to the reduced dependencies of the new core functionality, and include them in storage memory.

This method is shown diagrammatically in FIG. 3. The mechanism provides the ability to build core OS images which minimise the amount of XIP memory that needs to be used in each device that is a member of a product family. Components in the core OS image continue to use the reduced variants also found in the core, as they are statically linked at build time to those variants.

If the core OS variant is also held in storage memory it will link to the variant found in storage memory.

Other components in storage memory, and any application installed post-manufacture, will link to the full variants, satisfying any compatibility requirements.

If usage at boot-time of functions in the core image is X % (in terms of the number of bytes) of a full executable tree, then the XIP usage at boot would decrease by (100−X) % at the expense of extra storage memory usage of X % (due to the duplication).

For an executable with a tiny variant in core and a full variant in storage memory, where of the tiny variant is Y % of the full variant, (100+Y) % of the full variant's size will be used up in XIP usage by the executable whenever the full variant needs to be loaded. However, the XIP memory consumed by the full variant will be freed when it is no longer needed, and given the larger number of full variants that no longer consume any XIP memory, the overall tradeoff is beneficial.

A further optimisation of the method described here is not to provide a full variant of an executable in storage memory, but to provide instead a variant that only contains the full version of those functions that are stubbed out in the tiny variant provided in the core. Those functions that are provided in full in the core are stubbed out in the variant provided in storage memory. When a client using the storage variant calls a function only contained in the core, the stub in the storage variant would then forward it to the core variant's function.

In other words, the tiny variant and the variant in storage memory complement each other. We shall refer to the variant in storage memory as the complemented variant. Neither variant individually provides a full version of the functions in the original executable, but they do when taken together; every function is fully provided in either the tiny variant in the core OS image or the complemented variant in storage memory, but no functions are provided in both.

In the preferred embodiment the addresses of functions and methods provided in full in the tiny variant of an executable present in the core OS image are inserted into the export table of the variant of that executable provided in storage memory before that executable is placed in storage memory. The header of the executable provided in storage memory is modified before that executable is placed in storage memory to indicate where entries in the export table reference addresses of functions and methods provided in full in the tiny variant of that executable present in the core OS image, and the loader of that executable inspects its header and uses such indications to avoid further modifying the said entries in the export table.

Preferably, linkage involving elements of the core OS is managed statically and linkage involving modules present as separately loadable entities in storage memory is managed dynamically.

The use of complemented variants can ensure that no code is unnecessarily duplicated and therefore saves memory. We now discuss in more detail how this optimisation can be implemented.

As described earlier, all executables in the core OS image are statically linked to the tiny variant. There is no need for any calls made by these executables to the tiny variant to be forwarded to the complemented variant, since the whole point of having a tiny variant is that it completely satisfies the requirement of the executables in the core OS image. Executables in storage memory, however, will link to any complemented variant which is also present in storage memory. These variants need to be able to forward calls made to them on to the tiny variant in the core OS image for all functions which they do not fully implement themselves.

As an example case, we shall consider an original fully featured DLL named X which is further identified by a conventional version number in major version/minor version form. This DLLX [Major/minor version] provides methods f1( ), f2( ) and f3( ), and is shown in FIG. 2.

In order to reduce the size of the core image and the consequent impact on system RAM usage, this executable is split into two: DLLX [Major/minor+1 version] is the tiny variant provided within the core image and DLLX[Major/minor+2 version] is the complemented variant provided in storage memory (“ROFS”).

The tiny variant contains an implementation only of method f1( ), as it is the only method utilized by the other modules in the core, which are linked to it statically. The unused methods f2( ) and f3( ) in this variant are stubbed and marked as ABSENT.

The complemented variant contains implementations of methods f2( ) and f3( ). Method f1( ) in this variant is stubbed and marked as ABSENT. The addresses of all the methods provided in this variant are made public in a table of exported functions; these are in turn picked up by the loader of any executable modules that depend on DLLX. The loader functions as a dynamic linker and fixes up any references to the methods in DLLX to point to the correct addresses.

For the optimisation to work, the dynamic linking with the complemented variant has to work in such a way as to ensure that references to f2( ) and f3( ) are fixed up in the normal way, but that references to f1( ) are fixed up with the address of the method in the tiny variant.

The exact method that is used to do this may be varied for use with different operating systems, but the basic principles are as described above. A specific implementation will now be described with reference to the Symbian OS advanced operating system for mobile wireless devices. It should be noted that this implementation is described only for the purposes of illustration of the general principles and is not intended to limit the scope of the invention in any way. For example, those skilled in the art will appreciate that the principles set out above can be applied to any operating system which includes a run-time program loader that inspects executable file headers.

The workings of program loading and dynamic run-time linking in Symbian OS are described in the Chapter 10 of ‘Symbian OS Internals’ edited by Jane Sales, published by Wiley in 2005, ISBN 0-470-02524-7. A Symbian OS executable includes a pointer to an .edata table at offset 0x58 in the executable file header. This is a table containing the export directory:
“The export directory is a table supplying the address of each function exported from this executable. Each entry holds the start address of the function as an offset relative to the start of the code section:

00
Address of 1st function exported from this executable.
04
Address of 2nd function exported from this executable.
...
4n-4
Address of last function exported from this executable.

The order of exports in the table corresponds to the order in the DEF file for this executable. The table is not null terminated. Instead, the number of entries in the table is available from the file's image header.” ibid. p. 388

In the case of the complemented variant, the .edata table needs to ensure that the entry for f1( ) is actually populated with the address of the implementation in the code section. This is done at the time the embedded software (commonly called the ROM) for the device is built. It will be recalled that the ROM includes both a core OS image, which will include all tiny variants, and a number of non-core files in a read-only file system (ROFS) which will include all complemented variants. A redirect tool is provided with information on f1( ) which is used to construct an export table for the complemented variant that delegates its implementation to the tiny variant.

This redirect tool, during the ROM build, picks up the absolute address of f1( ) in the core OS image. Before the non-core ROFS portion of the ROM is built, the tool fixes the .edata table in the complemented variant provided in ROFS with the address for f1( ) retrieved from the core OS image.

However, the address for f1( ) so inserted is an absolute address, while the normal addresses for f2( ) and f3( ) in the export table are, by necessity, relative addresses. This is because no dynamically loaded executable knows in advance where in memory it is going to be loaded; so any addresses for exported functions have to be given relative to the beginning of the executable. One of the jobs of the loader is to fix up the export table to ensure that all entries point at the correct absolute address.

The loader therefore has to be told that while it is quite welcome to fix up the addresses of f2( ) and f3( ) in the usual way, the address of f1( ) should be left alone, as it is already absolute.

In Symbian OS, this is done by means of an extension to the executable file header (the E32ImageHeader described in Appendix 2 of ‘Symbian OS Internals’. A new “redirect-to-rom” bitmap is added to the module V-header and the redirect tool sets the corresponding bit in the bitmap in order to indicate to the loader that the address of a particular ordinal in the export table is fixed.

The loader is also modified to examine the “redirect-to-rom” bitmap during the loading of the complemented variant, and it does not fix up the address of any entry in the export table if the entry in the bitmap is set.

The effect of this optimisation is shown diagrammatically in FIG. 2. It allows the maximum amount of saving not just of the memory used by the statically linked modules present in the core OS image loaded at boot, but also of the memory used by dynamically linked variant modules provided as separate files in storage memory.

It can be seen from the example described above that the following advantages can result from embodiments of the invention:
The size of an OS core image in a NAND Flash computing device can be reduced in proportion to the feature set provided while retaining binary compatibility with other devices in the same family which are fully featured.
The smaller size of the core OS image in NAND Flash means that the image consumes less RAM once loaded.
The smaller size of the core OS image in NAND Flash means that the device will boot up faster.
The fact that less RAM is required means that devices with a reduced feature set are able to be manufactured at a lower cost.
The fact that less RAM is required means that a device with a reduced feature set will consume less power.
The complemented variant optimisation of the preferred embodiment extends the memory saving to dynamically loaded variant of modules provided as files in NAND Flash.

It will be understood by the skilled person that alternative implementations are possible, and that various modifications of the methods and implementations described above may be made within the scope of the invention, as defined by the appended claims.

1. A method of reducing the size of a set of computer code intended for use in a computing device, the code comprising a plurality of files, each specifying one or more functions for performing computing tasks, the method comprising:
identifying functions within the set of code that:
i) are available to be called by others of the functions; and
ii) will not be called by others of the functions when the files are executed on the computing device; and
removing from the set of code at least part of the content defining the identified functions while retaining, in place of each identified function, a void function of reduced size.

2. A method according to claim 1 wherein the void function contains no operative code.

3. A method according to claim 1 wherein each of the identified functions in the set of code is associated with an ordinal number specifying the position of the function within a defined order, and, for each identified function, the step of removing content results in the creation of a void function having the same ordinal number as the identified function.

4. A method according to claim 1 wherein the set of code is an operating system.

5. A method according to claim 1 wherein the set of code is a part of an operating system.

6. A method according to claim 1 wherein the said identified functions are exported functions.

7. A method according to claim 1 further comprising, for at least one of the files containing one or more void functions, creating complementary code for the respective file, the complementary code containing functionality that was removed in the said step of removing at least part of the content, such that a combination of:
i) the reduced file containing one or more void functions, and
ii) the complementary code,
provides functionality equivalent to that of the original file.

8. A method according to claim 7 further comprising the step of storing:
i) the set of code, including the reduced file, and
ii) the complementary code
as separately loadable files in storage memory of the computing device in which code cannot execute in place.

9. A method according to claim 8 further comprising providing a linking arrangement configured to link between functions in the reduced set of code and functions in the complementary code, such that all functionality provided by the original set of code can be provided by the combination of the reduced set of code and the complementary code.

10. A method according to claim 1 further comprising the step of storing:
i) the reduced set of code, including any void functions, and
ii) each file that contains identified functions, in its original form,
as separately loadable files in storage memory of the computing device in which code cannot execute in place.

11. A method according to claim 10 further comprising a linking arrangement configured to link between functions in the reduced set of code and functions in the said separately loadable files, such that all functionality provided by the original set of code can be provided by the combination of the reduced set of code and the separately loadable files.

12. A method according to claim 1 further comprising removing from the set of code any files containing only void functions.

13. A method according to claim 12 further comprising storing, in storage memory of the computing device in which code cannot execute in place, and as separately loadable files, the said removed files in the form in which they existed prior to the step of removing content defining the said identified functions.

14. A method according to claim 1 further comprising the steps of:
identifying further functions within the set of code that:
i) are available to be called by other functions within the same files as the said further functions; and
ii) will not be called by other functions when the files are executed on the computing device; and
removing from the set of code the identified further functions.

15. A set of code intended for use on a computing device, the set of code comprising a plurality of files, each specifying one or more functions for performing computing tasks, wherein those of the functions that:
i) are available to be called by others of the functions; and
ii) will not be called by others of the functions when the files are executed on the computing device;
are present in the set of code only as void functions having no operative code.

16. A set of code according to claim 15 wherein the void functions represent exported functions.

17. An operating system comprising the set of code according to claim 15.

18. A computing device having non-volatile memory, the memory containing the set of code according to claim 15.

19. A computing device according to claim 18 wherein the memory is storage memory in which code cannot execute in place.

20. A computing device according to claim 18 wherein the memory additionally contains, as one or more separately loadable files, complementary code including operative functions, the complementary code being arranged for execution with one or more of the void functions to perform computing tasks.

21. A computing device according to claim 20 wherein each void function is associated with an ordinal number specifying the position of the function within a defined order, and wherein the complementary code is arranged to be invoked by linking via an ordinal number associated with a void function in the set of code.

22. A computing device according to claim 18 wherein the memory additionally contains, as one or more separately loadable files, operative functions each associated with one of the void functions.
